(19) United States
(12) Patent Application Publication
(10) Pub. No.: US 2025/0256389 A1
(43) Pub. Date: Aug. 14, 2025

(54) MAGNETIC ELECTRICIAN TOOL POUCH DEVICE

(71) Applicant: Efren Aguirre, Bakersfield, CA (US)

(72) Inventor: Efren Aguirre, Bakersfield, CA (US)

(21) Appl. No.: 19/051,311

(22) Filed: Feb. 12, 2025

Related U.S. Application Data
(60) Provisional application No. 63/552,833, filed on Feb. 13, 2024.

(51) Int. Cl. B25H 3/02; F16B 1/00

(52) U.S. Cl. CPC B25H 3/022; F16B 1/00; F16B 2200/83

(57) ABSTRACT

A magnetic electrician tool pouch device is disclosed, which is a modified tool pouch that can magnetically attach to nearby surfaces. The magnetic electrician tool pouch device comprises a base component that is configured in a pocket or pouch configuration. The base component includes a plurality of different-sized pockets. The base component also comprises a loop to receive clip-on tools and a tape chain to hold a roll of tape. The base component also comprises a magnet on the back side that allows the device to magnetically adhere to an electrical panel box. Further, the front side of the magnet comprises a rubberized, dish-like surface that can hold screws and nuts.

### CROSS-REFERENCE TO RELATED APPLICATION

The present application claims priority to, and the benefit of, U.S. Provisional Application No. 63/552,833, which was filed on Feb. 13, 2024, and is incorporated herein by reference in its entirety.

### FIELD OF THE INVENTION

The present invention relates generally to the field of magnetic electrician tool pouch devices. More specifically, the present invention relates to an improved tool pouch that can magnetically attach to nearby surfaces. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in magnetic electrician tool pouch devices. Nearly all electricians use a tool pouch to store their tools. However, tool pouches must be worn on the body or placed on the ground by a working area. This is undesirable, as a user must often bend down to use and replace tools from the pouch. Additionally, tool holders can be easily misplaced, causing frustration and wasting time at the jobsite looking for them. Further, users of tools in assembly or repair work, or even home and office work, often encounter a need to have easy access to and portability of tools. Further, electricians often work on metal electrical panels. Thus, a need exists for a magnetic tool holder, which is portable and can conform to various contoured mounting surfaces, such as a metal electrical panel.

Accordingly, there is a demand for an improved magnetic electrician tool pouch device that mounts easily to electrical panels, appliances, ducts, and other convenient magnetic surfaces. More particularly, there is a demand for a magnetic electrician tool pouch device that saves time and prevents aggravation over misplaced tools.

Therefore, there exists a long felt need in the art for a magnetic electrician tool pouch device that provides users with a tool pouch that mounts easily to electrical panels, appliances, ducts, and other convenient magnetic surfaces. There is also a long felt need in the art for a magnetic electrician tool pouch device that allows users to easily find the right tools. Further, there is a long felt need in the art for a magnetic electrician tool pouch device that saves time and prevents aggravation over misplaced tools. Moreover, there is a long felt need in the art for a device that comprises durable materials and plenty of space for custom tool organization. Further, there is a long felt need in the art for a magnetic electrician tool pouch device that comprises heavy duty magnets that can support the weight of a fully loaded tool collection. Finally, there is a long felt need in the art for a magnetic electrician tool pouch device that includes different sized pockets for arranging tools, as needed.

The subject matter disclosed and claimed herein, in one embodiment thereof, comprises a magnetic electrician tool pouch device. The device is a modified tool pouch that can magnetically attach to nearby surfaces. The magnetic electrician tool pouch device comprises a base component that is configured in a pocket or pouch configuration. The base component includes a plurality of different-sized pockets. The base component also comprises a loop to receive clip-on tools and a tape chain to hold a roll of tape. The base component also comprises a magnet on the back side that allows the device to magnetically adhere to an electrical panel box. Further, the front side of the magnet comprises a rubberized, dish-like surface that can hold screws and nuts.

In this manner, the magnetic electrician tool pouch device of the present invention accomplishes all of the forgoing objectives and provides users with a device that magnetically secures to an electrical panel box or other suitable area. The device is a tool pouch with a magnetic backing. The device comprises a plurality of pockets.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a magnetic electrician tool pouch device. The device is a modified tool pouch that can magnetically attach to nearby surfaces. The magnetic electrician tool pouch device comprises a base component that is configured in a pocket or pouch configuration. The base component includes a plurality of different-sized pockets and other components to retain a plurality of tools. The base component also comprises a magnet on the back side that allows the device to magnetically adhere to an electrical panel box or other suitable surface.

In one embodiment, the magnetic electrician tool pouch device provides users with a temporary, portable and easily repositionable magnetic tool holder which can be positioned on magnetically responsive mounting surfaces having varying contours. The magnetic electrician tool pouch of the invention can be used by electricians, mechanics, plumbers, oil drillers, etc., to hold tools, such as multimeters, wire strippers, screwdrivers, pliers, hammers, or wrenches, etc., or other suitable tools of the trade as is known in the art. Uses of the present invention are not limited to the above-described uses or activities; the present invention can be used in almost any application requiring the holding of tools. The use of the word “tool” throughout the specification and claims includes any object used in installing or repairing an item. Such objects can include hand-held tools, industrial tools, power tools, tape rolls, tape measures, and hardware (i.e., nails, screws, nuts, bolts, paperclips, etc.). The use of the term “metal” or “metallic” throughout the specification and claims means any material, metal or alloy which is attracted to a magnet.

In one embodiment, the magnetic electrician tool pouch device comprises a base component having a front side and a back side, opposing side edges, and opposing top and bottom edges. At least one embedded heavy-duty magnet is sewn into a pocket or other holding portion that extends up from and is secured to a top edge of the base component. The heavy-duty magnets are sized and shaped to support the weight of a fully loaded tool collection. The embedded magnets are retained within the pocket by a scaling means, common to the art, such as stitching or gluing, to hold the magnet in the interior holding portion. Any suitable number of magnets can be utilized with the device. The embedded magnets are typically configured in a square or rectangular shape but can be any suitable shape and size as is known in the art to allow the device to conform to a variety of surfaces. Generally, the embedded magnets are positioned in the pocket or other holding portion, such that the embedded magnets will attract metal on both sides of the embedded magnets. With this positioning of the embedded magnets, the device can be attached to and easily pulled away from a mounting surface and repositioned on another mounting surface. For example, the back side of the embedded magnets are mounted on a metallic surface to position the device so that a user can access tools. The other side, front face of the embedded magnets are rubberized and form a dish to hold screws and nuts while the electrician is working. This will help in storing small metallic objects, such as nuts, screws, nails, and bolts, within the rubberized magnetic dish to prevent them from being dislodged or lost.

In one embodiment, the base component is made of a durable, flexible material so that the device can be positioned on mounting surfaces having varying contours, such as an uneven or a curved surface. For example, the device can be positioned on an electrical panel, appliances, ducts, a round pipe or column, etc., or other suitable magnetic surfaces due to the flexible base component. Flexible materials which are useful for the base component include, but are not limited to, leather, simulated leather, plastic, nylon, canvas, and cloth. The material selected for the base component may also be an insulative material, such as polycarbonate, for placement of the device on a hot or electrically conductive mounting surface. Such a material would prevent the tools from getting hot and could also offer protection for the user against the heat or electrical conductivity of the mounting surface.

In one embodiment, the base component comprises a plurality of pockets for retaining tools. The base component can have any suitable number of pockets of different shapes and sizes, as is known in the art depending on the needs and/or wants of a user and the amount and style of tools to be held. In one embodiment, the base component comprises one extra-large pocket for a multimeter, wire strippers, or other large tools. Further, two medium pockets are included for screwdrivers and pliers, etc. Additionally, four elastic pockets for precision tools and other tools are included on the front side of the base component. Furthermore, one large side pocket for multitools or the most commonly used tool for the user can be included on one side of the base component.

In one embodiment, the base component comprises at least one nylon loop secured to the front side of the base component. The nylon loops are used to secure clip-on tools, such as tape measures and other suitable tools that can be secured to the loops during use. Generally, the loops can serve two functions. First, the user may insert tools to hang from the loops or the user can clip-on tools to the loops.

In one embodiment, the base component comprises a tape chain secured to the base component. The tape chain can be any suitable length as is known in the art. The tape chain is sized and shaped to retain a roll of electrician's tape or other suitable tape roll as is known in the art.

In yet another embodiment, the magnetic electrician tool pouch device comprises a plurality of indicia.

In yet another embodiment, a method of magnetically securing a tool pouch to a nearby surface is disclosed. The method includes the steps of providing a magnetic electrician tool pouch device comprising a base component with a plurality of pockets. The method also comprises securing the base component to a magnetic surface via a magnet on the back side. Further, the method comprises filling the pockets with tools. The method also comprises securing screws and nuts within the magnetic dish secured at the top of the device. Finally, the method comprises utilizing the device near a worksite to access tools and secure screws.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the magnetic electrician tool pouch device of the present invention in accordance with the disclosed architecture;

FIG. 2 illustrates a perspective view of one embodiment of the magnetic electrician tool pouch device of the present invention showing the loop for tools and tape chain in accordance with the disclosed architecture;

FIG. 3 illustrates a perspective view of one embodiment of the magnetic electrician tool pouch device of the present invention showing the durability of the pouch in accordance with the disclosed architecture;

FIG. 4 illustrates a perspective view of one embodiment of the magnetic electrician tool pouch device of the present invention showing the magnetic dish in accordance with the disclosed architecture;

FIG. 5 illustrates a front perspective view of one embodiment of the magnetic electrician tool pouch device of the present invention in accordance with the disclosed architecture;

FIG. 6 illustrates a side perspective view of one embodiment of the magnetic electrician tool pouch device of the present invention in accordance with the disclosed architecture;

FIG. 7 illustrates a top perspective view of one embodiment of the magnetic electrician tool pouch device of the present invention in accordance with the disclosed architecture;

FIGS. 8A and 8B illustrate a perspective view of one embodiment of the magnetic electrician tool pouch device of the present invention secured to an electrical box in accordance with the disclosed architecture;

FIGS. 9A, 9B, 9C, and 9D illustrate a perspective view of one embodiment of the magnetic electrician tool pouch device of the present invention in use in accordance with the disclosed architecture; and

FIG. 10 illustrates a flowchart showing the method of magnetically securing a tool pouch to a nearby surface in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a magnetic electrician tool pouch device that provides users with a tool pouch that mounts easily to electrical panels, appliances, ducts, and other convenient magnetic surfaces. There is also a long felt need in the art for a magnetic electrician tool pouch device that allows users to easily find the right tools. Further, there is a long felt need in the art for a magnetic electrician tool pouch device that saves time and prevents aggravation over misplaced tools. Moreover, there is a long felt need in the art for a device that comprises durable materials and plenty of space for custom tool organization. Further, there is a long felt need in the art for a magnetic electrician tool pouch device that comprises heavy duty magnets that can support the weight of a fully loaded tool collection. Finally, there is a long felt need in the art for a magnetic electrician tool pouch device that includes different sized pockets for arranging tools, as needed.

The present invention, in one exemplary embodiment, is a novel magnetic electrician tool pouch device. The device is a modified tool pouch that can magnetically attach to nearby surfaces. The magnetic electrician tool pouch device comprises a base component that is configured in a pocket or pouch configuration. The base component includes a plurality of different-sized pockets. The base component also comprises a loop to receive clip-on tools and a tape chain to hold a roll of tape. The base component also comprises a magnet on the back side that allows the device to magnetically adhere to an electrical panel box. Further, the front side of the magnet comprises a rubberized, dish-like surface that can hold screws and nuts. The present invention also includes a novel method of magnetically securing a tool pouch to a nearby surface. The method includes the steps of providing a magnetic electrician tool pouch device comprising a base component with a plurality of pockets. The method also comprises securing the base component to a magnetic surface via a magnet on the back side. Further, the method comprises filling the pockets with tools. The method also comprises securing screws and nuts within the magnetic dish secured at the top of the device. Finally, the method comprises utilizing the device near a worksite to access tools and secure screws.

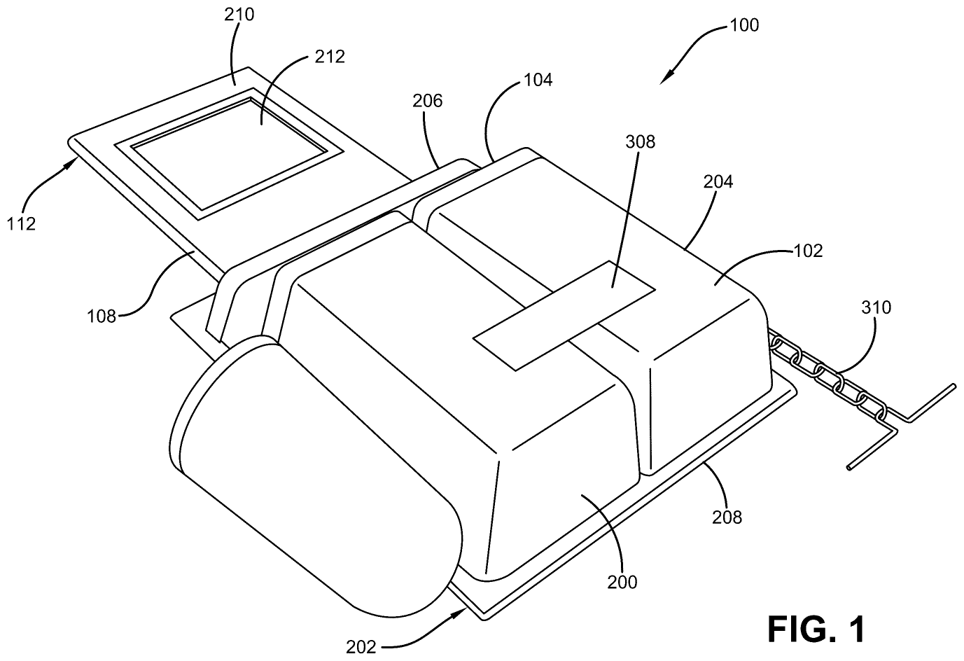

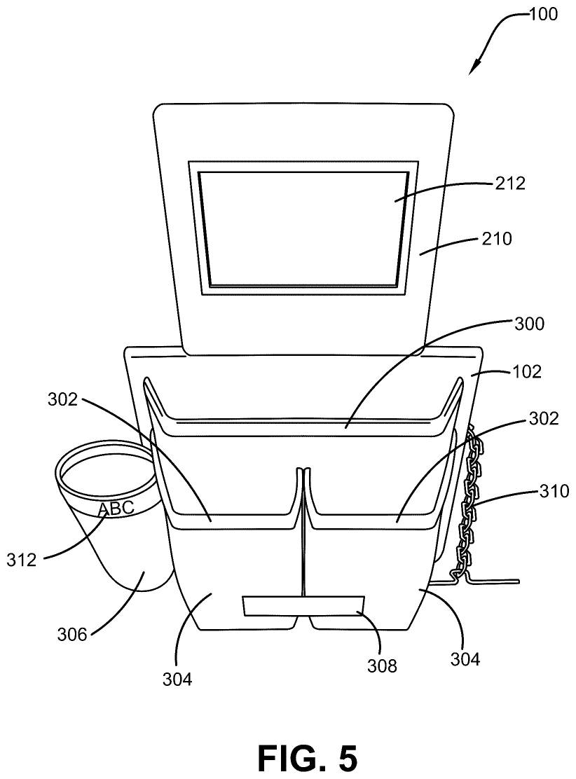

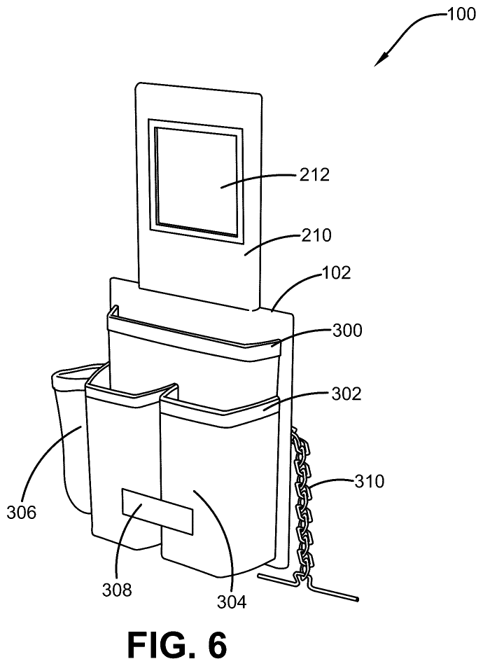

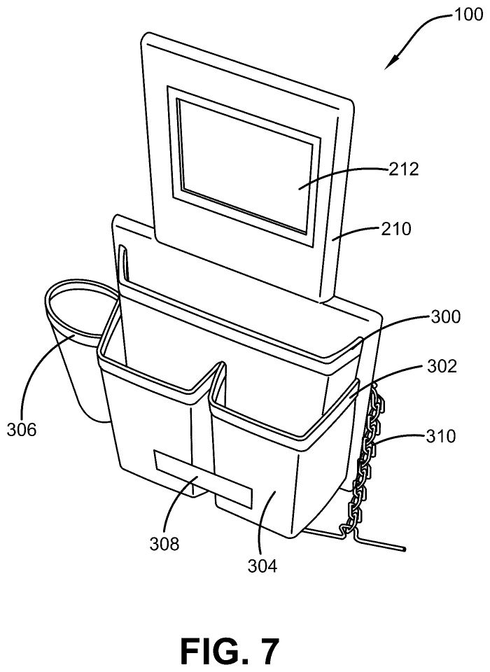

Referring initially to the drawings, FIGS. 1 and 5-7 illustrate a perspective view of one embodiment of the magnetic electrician tool pouch device 100 of the present invention. In the present embodiment, the magnetic electrician tool pouch device 100 is an improved magnetic electrician tool pouch device 100 that provides a user with a means for easily accessing tools 106 by magnetically attaching to nearby surfaces. Specifically, the magnetic electrician tool pouch device 100 comprises a base component 102 with a plurality of pockets 104 to retain a plurality of tools 106. The base component 102 also comprises a magnet 108 on the back side 112 that allows the device 100 to magnetically adhere to an electrical panel box 110 or another suitable surface.

Generally, the magnetic electrician tool pouch device 100 provides users with a temporary, portable and easily repositionable magnetic tool holder which can be positioned on magnetically responsive mounting surfaces having varying contours. The magnetic electrician tool pouch 100 of the invention can be used by electricians, mechanics, plumbers, oil drillers, etc., to hold tools 106, such as multimeters, wire strippers, screwdrivers, pliers, hammers, or wrenches, etc., or other suitable tools of the trade as is known in the art. Uses of the present invention are not limited to the above-described uses or activities; the present invention can be used in almost any application requiring the holding of tools 106. The use of the word “tool” throughout the specification and claims includes any object used in installing or repairing an item. Such objects can include hand-held tools, industrial tools, power tools, tape rolls, tape measures, and hardware (i.e., nails, screws, nuts, bolts, paperclips, etc.). The use of the term “metal” or “metallic” throughout the specification and claims means any material, metal or alloy which is attracted to a magnet.

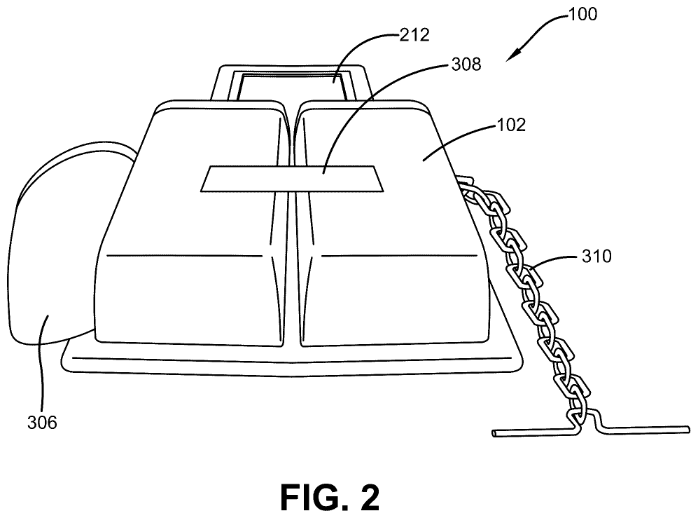

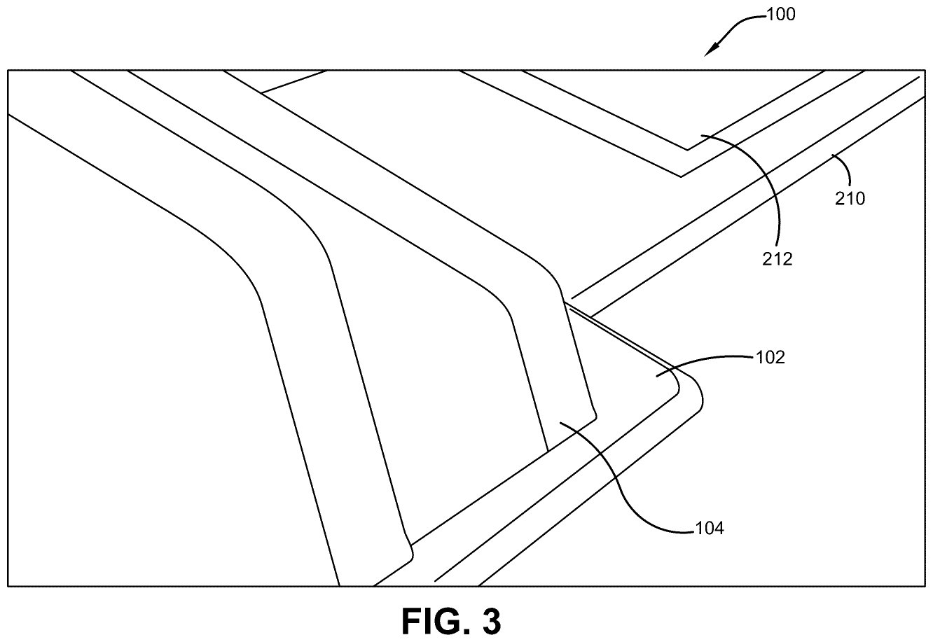

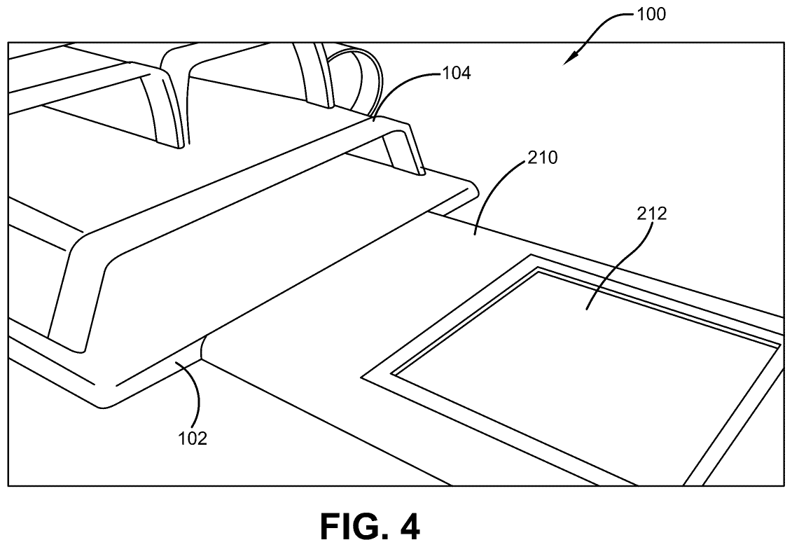

As shown in FIGS. 2-4, the magnetic electrician tool pouch device 100 comprises a base component 102 having a front side 200 and a back side 202, opposing side edges 204, and opposing top 206 and bottom 208 edges. At least one embedded heavy-duty magnet 108 is sewn into a pocket 210 or other holding portion that extends up from and is secured to a top edge 206 of the base component 102. The heavy-duty magnets 108 are sized and shaped to support the weight of a fully loaded tool collection. The embedded magnets 108 are retained within the pocket 210 by a sealing means, common to the art, such as stitching or gluing, to hold the magnet 108 in the interior holding portion 210. Any suitable number of magnets 108 can be utilized with the device 100. The embedded magnets 108 are typically configured in a square or rectangular shape but can be any suitable shape and size as is known in the art to allow the device 100 to conform to a variety of surfaces. Generally, the embedded magnets 108 are positioned in the pocket 210 or other holding portion, such that the embedded magnets 108 will attract metal on both sides of the embedded magnets 108. With this positioning of the embedded magnets 108, the device 100 can be attached to and easily pulled away from a mounting surface and repositioned on another mounting surface. For example, the back side 202 of the embedded magnets 108 are mounted on a metallic surface to position the device 100 so that a user can access tools 106. The other side, front face 200 of the embedded magnets 108 are rubberized and form a dish 212 to hold screws and nuts while the electrician is working. This will help in storing small metallic objects, such as nuts, screws, nails, and bolts, within the rubberized magnetic dish 212 to prevent them from being dislodged or lost.

Further, the base component 102 is made of a durable, flexible material so that the device 100 can be positioned on mounting surfaces having varying contours, such as an uneven or a curved surface. For example, the device 100 can be positioned on an electrical panel 110, appliances, ducts, a round pipe or column, etc., or other suitable magnetic surfaces due to the flexible base component 102. Flexible materials which are useful for the base component 102 include, but are not limited to, leather, simulated leather, plastic, nylon, canvas, and cloth. The material selected for the base component 102 may also be an insulative material, such as polycarbonate, for placement of the device 100 on a hot or electrically conductive mounting surface. Such a material would prevent the tools 106 from getting hot and could also offer protection for the user against the heat or electrical conductivity of the mounting surface.

Additionally, the base component 102 comprises a plurality of pockets 104 for retaining tools 106. The base component 102 can have any suitable number of pockets 104 of different shapes and sizes, as is known in the art depending on the needs and/or wants of a user and the amount and style of tools 106 to be held. In one embodiment, the base component 102 comprises one extra-large pocket 300 for a multimeter, wire strippers, or other large tools. Further, two medium pockets 302 are included for screwdrivers and pliers, etc. Additionally, four elastic pockets 304 for precision tools and other tools 106 are included on the front side 200 of the base component 102. Furthermore, one large side pocket 306 for multitools or the most commonly used tool for the user can be included on one side 204 of the base component 102.

Furthermore, the base component 102 comprises at least one nylon loop 308 secured to the front side 200 of the base component 102. The nylon loops 308 are used to secure clip-on tools, such as tape measures and other suitable tools 106 that can be secured to the loops 308 during use. Generally, the loops 308 can serve two functions. First, the user may insert tools 106 to hang from the loops 308 or the user can clip-on tools to the loops 308.

Further, the base component 102 comprises a tape chain 310 secured to the base component 102. The tape chain 310 can be any suitable length as is known in the art. The tape chain 310 is sized and shaped to retain a roll of electrician's tape or other suitable tape roll as is known in the art.

In yet another embodiment, the magnetic electrician tool pouch device 100 comprises a plurality of indicia 312. The base component 102 of the device 100 may include advertising, a trademark, or other letters, designs, or characters, printed, painted, stamped, or integrated into the base component 102, or any other indicia 312 as is known in the art. Specifically, any suitable indicia 312 as is known in the art can be included, such as but not limited to, patterns, logos, emblems, images, symbols, designs, letters, words, characters, animals, advertisements, brands, etc., that may or may not be magnet, tool pouch, or brand related.

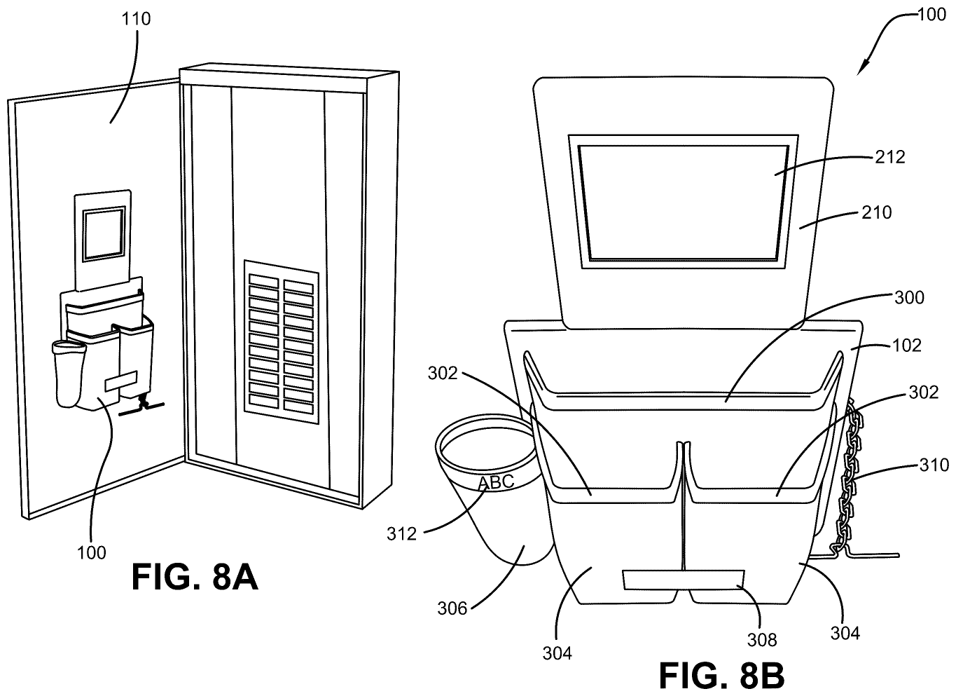

As shown in FIGS. 8A-B and 9A-D, in use, a user secures the magnetic electrician tool pouch device 100 to a magnetic surface, such as an electrical box 110 or work truck. The user can then fill the tool pouch device 100 with tools 106 for use. The device 100 saves time and prevents aggravation over misplaced tools 106. Thus, the device 100 allows the user to easily find the tools 106 they want, right in front of them.

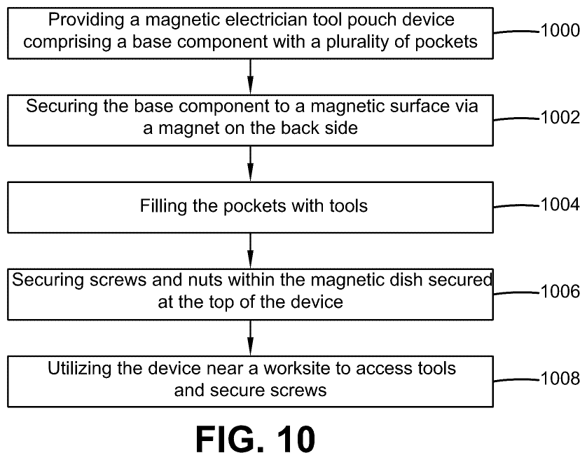

FIG. 10 illustrates a flowchart of the method of magnetically securing a tool pouch to a nearby surface. The method includes the steps of at 1000, providing a magnetic electrician tool pouch device comprising a base component with a plurality of pockets. The method also comprises at 1002, securing the base component to a magnetic surface via a magnet on the back side. Further, the method comprises at 1004, filling the pockets with tools. The method also comprises at 1006, securing screws and nuts within the magnetic dish secured at the top of the device. Finally, the method comprises at 1008, utilizing the device near a worksite to access tools and secure screws.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “magnetic electrician tool pouch device”, “tool pouch device”, “magnetic device”, and “device” are interchangeable and refer to the magnetic electrician tool pouch device 100 of the present invention.

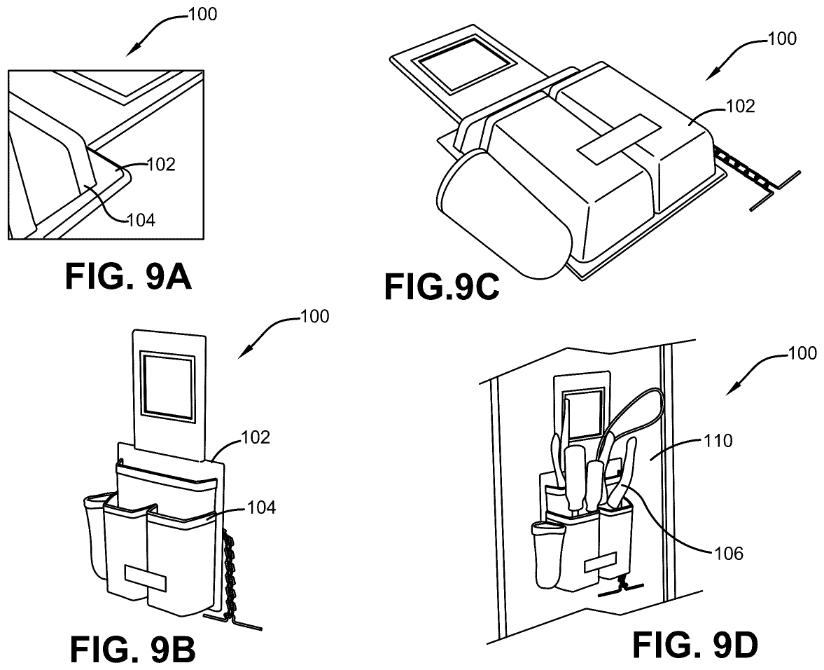

Notwithstanding the forgoing, the magnetic electrician tool pouch device 100 of the present invention can be of any suitable size and configuration as is known in the art without affecting the overall concept of the invention, provided that it accomplishes the above stated objectives. One of ordinary skill in the art will appreciate that the magnetic electrician tool pouch device 100 as shown in FIGS. 1-10 is for illustrative purposes only, and that many other sizes and shapes of the magnetic electrician tool pouch device 100 are well within the scope of the present disclosure. Although the dimensions of the magnetic electrician tool pouch device 100 are important design parameters for user convenience, the magnetic electrician tool pouch device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A magnetic electrician tool pouch device that provides a user with a tool pouch that is magnetically attached to nearby surfaces, the magnetic electrician tool pouch device comprising:
a base component; and
at least one magnet;
wherein the base component comprises a plurality of pockets to retain a plurality of tools;
wherein the at least one magnet is secured to the base component; and
further wherein the base component is magnetically adhered to an electrical panel box via the at least one magnet.

2. The magnetic electrician tool pouch device of claim 1, wherein the base component comprises a front side and a back side, opposing side edges, and opposing top and bottom edges.

3. The magnetic electrician tool pouch device of claim 2, wherein the at least one magnet is a heavy-duty magnet.

4. The magnetic electrician tool pouch device of claim 3, wherein the at least one magnet is sewn into a pocket that extends up from and is secured to a top edge of the base component.

5. The magnetic electrician tool pouch device of claim 4, wherein a back side of the at least one embedded magnet are mounted on a metallic surface to position the magnetic electrician tool pouch device so that a user can access tools from the plurality of pockets.

6. The magnetic electrician tool pouch device of claim 5, wherein a front side of the at least one magnet forms a rubberized dish to hold screws and nuts while an electrician is working.

7. The magnetic electrician tool pouch device of claim 6, wherein the base component is made of a durable, flexible material so that the magnetic electrician tool pouch device can be positioned on various mounting surfaces.

8. The magnetic electrician tool pouch device of claim 7, wherein the base component comprises one extra-large pocket for a multimeter, wire strippers, or other large tools.

9. The magnetic electrician tool pouch device of claim 8, wherein the base component comprises two medium pockets are included for screwdrivers and pliers, etc.

10. The magnetic electrician tool pouch device of claim 9, wherein the base component comprises four elastic pockets for precision tools and other tools included on the front side of the base component.

11. The magnetic electrician tool pouch device of claim 10, wherein the base component comprises one large side pocket for multitools or other large tools on one side of the base component.

12. The magnetic electrician tool pouch device of claim 11, wherein the base component comprises at least one nylon loop for clip-on tools, which is secured to the front side of the base component.

13. The magnetic electrician tool pouch device of claim 12, wherein the base component comprises a tape chain secured to the base component to hold rolls of tape.

14. A magnetic electrician tool pouch device that provides a user with a tool pouch that is magnetically attached to nearby surfaces, the magnetic electrician tool pouch device comprising:
a base component comprising a front side and a back side, opposing side edges, and opposing top and bottom edges and a plurality of pockets; and
at least one magnet which is sewn into a pocket that extends up from and is secured to a top edge of the base component;
wherein a back side of the at least one embedded magnet is mounted on a metallic surface to position the magnetic electrician tool pouch device so that a user can access tools from the plurality of pockets;
wherein the base component comprises one extra-large pocket for a multimeter, wire strippers, or other large tools;
wherein the base component comprises two medium pockets are included for screwdrivers and pliers, etc;
wherein the base component comprises four elastic pockets for precision tools and other tools included on the front side of the base component;
wherein the base component comprises one large side pocket for multitools or other large tools on one side of the base component;
wherein a front side of the at least one magnet forms a rubberized dish to hold screws and nuts while an electrician is working; and
further wherein the base component is magnetically adhered to an electrical panel box via the at least one magnet.

15. The magnetic electrician tool pouch device of claim 14, wherein the base component comprises at least one nylon loop for clip-on tools, which is secured to the front side of the base component.

16. The magnetic electrician tool pouch device of claim 14, wherein the base component comprises a tape chain secured to the base component to hold rolls of tape.

17. The magnetic electrician tool pouch device of claim 14, wherein the base component is made of a durable, flexible material so that the magnetic electrician tool pouch device can be positioned on various mounting surfaces.

18. The magnetic electrician tool pouch device of claim 14 further comprising a plurality of indicia.

19. The magnetic electrician tool pouch device of claim 14 wherein the at least one magnet is a heavy-duty magnet.

20. A method of magnetically securing a tool pouch to a nearby surface, the method comprising the following steps:
providing a magnetic electrician tool pouch device comprising a base component with a plurality of pockets;
securing the base component to a magnetic surface via a magnet on the back side;
filling the pockets with tools;
securing screws and nuts within the magnetic dish secured at the top of the device; and
utilizing the device near a worksite to access tools and secure screws.
